(19) United States
(12) Patent Application Publication
(10) Pub. No.: US 2026/0339090 A1
(43) Pub. Date: Oct. 29, 2026

(54) OBSERVATION METHOD AND APPARATUS USING OPTICAL DEVICE

(71) Applicant: CURIOSIS INC., Seoul (KR)

(72) Inventors: Youngho PARK, Seoul (KR); Sungeun AN, Seoul (KR); Bongwoo KIM, Seoul (KR); Taeyeon JO, Seoul (KR)

(73) Assignee: CURIOSIS INC., Seoul (KR)

(21) Appl. No.: 19/703,244

(22) Filed: Jun. 10, 2026

Related U.S. Application Data
(63) Continuation of application No. PCT/KR2025/015215, filed on Sep. 26, 2025.

(30) Foreign Application Priority Data
Sep. 26, 2024 (KR) 10-2024-0131178
May 16, 2025 (KR) 10-2025-0064203

(51) Int. Cl. G02B 21/18; G01N 15/1434; G02B 27/28

(52) U.S. Cl. CPC G02B 21/18; G01N 15/1434; G02B 27/283

(57) ABSTRACT

An example embodiment of the present disclosure provides an observation apparatus including: a first polarizer configured to polarize light emitted from a light source; a light splitter configured to split the light having passed through the first polarizer into a first reflected light and a first transmitted light; an objective lens configured to collect light including information about an object based on the first reflected light; an image sensor configured to sense light input to the image sensor based on the light collected by the objective lens; and a second polarizer configured to block the first transmitted light so that the first transmitted light is not detected by the image sensor.

### CROSS-REFERENCE TO RELATED APPLICATIONS

This application is a continuation of International Application No. PCT/KR2025/015215 filed on Sep. 26, 2025, which claims priority to Korean Patent Application No. 10-2024-0131178 filed on Sep. 26, 2024, and Korean Patent Application No. 10-2025-0064203 filed on May 16, 2025, the entire contents of which are herein incorporated by reference.

### TECHNICAL FIELD

The present disclosure relates to an observation method and apparatus using an optical device, and more particularly, to a method and apparatus for observing an object using a polarizer which polarizes light.

### BACKGROUND

An optical device such as a microscope can magnify and observe minute objects and is used as an important tool in a variety of disciplines such as biology, chemistry, and material science. In particular, an optical system equipped with an in-line illumination suppresses light incident perpendicularly to a surface from scattering, which makes it possible to easily observe an object without distortion due to reflection. The illumination and an observation path are arranged to match each other, so that a separate illumination angle adjustment mechanism is not required. This simplifies a design of the optical device.

However, the in-line illumination is primarily used only for the observation of macroscopic metals and objects. Such an in-line illumination system is not used in microscopes for biological application such as detailed structures of cells, tissues, protein structures, and other biomaterials. This is because, while a transmitted illumination is used and a light intensity of the illumination needs to be appropriately adjusted to observe transparent objects such as cells, light emitted from a light source of the in-line illumination is strong, which makes light emitted from microscopic and transparent cells invisible.

The present disclosure was made to solve the above-mentioned matters that the in-line illumination is not being used in an observation apparatus which observes such cells or the like.

### DOCUMENTS IN RELATED ART

### Patent Document

Korean Patent Application Registration No. 10-0813915 (publication date: Mar. 18, 2008)

### SUMMARY

### Problem to be Solved by the Invention

An example embodiment of the present disclosure provides an observation method and an observation apparatus, which use an optical device.

### Means for Solving Problem

According to an example embodiment of the present disclosure, there is provided an observation apparatus including: a first polarizer configured to polarize light emitted from a light source; a light splitter configured to split the light having passed through the first polarizer into a first reflected light and a first transmitted light; an objective lens configured to collect light including information about an object based on the first reflected light; an image sensor configured to sense light input to the image sensor based on the light collected by the objective lens; and a second polarizer configured to block the first transmitted light so that the first transmitted light is not detected by the image sensor.

In an example embodiment, the light detected by the image sensor may include: at least one of a transmitted light available when the first reflected light is scattered above the object and the scattered light passes through the object or a scattered light available when the first reflected light passes through the object and subsequently is scattered above the object; or a scattered light available when the first reflected light is scattered at the object.

In an example embodiment, the light available when the first reflected light is scattered above the object may include light scattered by at least one of an upper plate of a vessel or a surface of media.

In an example embodiment, the light collected by the objective lens may include a reflected light reflected by at least one of the object, the vessel, or the surface of the media, and the reflected light, which has not been scattered, may be blocked by the second polarizer.

In an example embodiment, the observation apparatus may further include the light source provided inside the observation apparatus.

In an example embodiment, a polarization angle of the first polarizer may be set by 90 degrees with respect to a polarization angle of the second polarizer.

In an example embodiment, the second polarizer may be configured to polarize the light collected by the objective lens, and the image sensor may be configured to obtain the light polarized by the second polarizer.

In an example embodiment, the object may be accommodated in a single-layer vessel or a multi-layer vessel.

In an example embodiment, the multi-layer vessel may include a CellSTACK™, HYPERStack™, Cell Factory™, Nunc™ EasyFill™ Cell Factory, Falcon® Cell Culture Multi-Layer Flask, STACKMAX™, iCELLis™ Nano and iCELLis™ 500+, TripleFlask™ system, or HYPERFlask®.

In an example embodiment, the object may be accommodated in a vessel, and the vessel may include a lower plate and an upper plate, or includes the lower plate alone.

In an example embodiment, the object may be accommodated in a vessel which is made of an optically transparent material.

In an example embodiment, the observation apparatus may be a live cell imaging system.

According to another example embodiment of the present disclosure, there is provided an observation method including: emitting, by a light source, light; polarizing, by a first polarizer, the light emitted from the light source; splitting, by a light splitter, the light having passed through the first polarizer into a first reflected light and a first transmitted light; blocking, by a second polarizer, the first transmitted light so that the first transmitted light is not detected by an image sensor; collecting, by an objective lens, light including information about an object based on the first reflected light; and sensing, by the image sensor, light input to the image sensor based on the light collected by the objective lens.

In an example embodiment, the light detected by the image sensor may include: at least one of a transmitted light available when the first reflected light is scattered above the object and the scattered light passes through the object or a scattered light available when the first reflected light passes through the object and subsequently is scattered above the object; or a scattered light available when the first reflected light is scattered at the object.

In an example embodiment, the light available when the first reflected light is scattered above the object may include light scattered by at least one of an upper plate of a vessel or a surface of media.

In an example embodiment, the light collected by the objective lens may include a reflected light reflected by at least one of the object, the vessel, or the surface of the media, and the reflected light, which has not been scattered, may be blocked by the second polarizer.

An observation method according to another example embodiment of the present disclosure may include: scattering at least a portion of light emitted from a light source at an object or above the object; and sensing at least one of the light scattered at the object, a transmitted light available when the light is scattered above the object and subsequently passes through the object or a scattered light available when the light passes through the object and subsequently is scattered above the object.

According to another example embodiment of the present disclosure, there is provided a program stored in a recording medium to cause a computer to execute the observation method according to the example embodiment of the present disclosure.

According to another example embodiment of the present disclosure, there is provided a computer-readable recording medium that records a program for causing a computer to execute the observation method according to the example embodiment of the present disclosure.

According to another example embodiment of the present disclosure, there is provided a computer-readable recording medium that records a database used in an example embodiment of the present disclosure.

### Effect of Invention

According to an example embodiment of the present disclosure, an in-line illumination method may be used to observe minute objects such as cells.

Further, according to an example embodiment, even if a lower surface or the like of a vessel in which an observation object is accommodated is opaque or uneven, it is possible to obtain a clear observation image.

Further, according to an example embodiment, when observing a sample accommodated in a vessel in which an observation object is accommodated and a ceiling plate is not provided, such as Sharie without a lid, or in a cell culture fluid, it is possible to obtain a clear observation image even without a separate vessel or without disposing a reflective member above the observation object.

### BRIEF DESCRIPTION OF THE DRAWINGS

FIG. 1 is a diagram illustrating an optical system using an in-line illumination method according to an example embodiment of the present disclosure.

FIG. 2A is a diagram illustrating a situation in which light emitted from a light source reaches an observation object according to an example embodiment of the present disclosure.

FIG. 2B is a diagram illustrating a situation in which the light having passed through the observation object reaches an image acquisition part according to an example embodiment of the present disclosure.

FIG. 3 is a diagram illustrating an image obtained by observing a macroscopic object using an observation apparatus according to an example embodiment of the present disclosure.

FIGS. 4A to 4B are diagrams illustrating images obtained by observing a microscopic object using the observation apparatus according to an example embodiment of the present disclosure.

FIG. 5A is a diagram illustrating a bright-field imaging method for explaining the situation in which the light emitted from the light source reaches the observation object according to an example embodiment of the present disclosure.

FIG. 5B is a diagram illustrating the bright-field imaging method for explaining a situation in which light scattered or reflected at the observation object reaches the image acquisition part according to an example embodiment of the present disclosure.

FIG. 6A is a diagram illustrating a dark-field imaging method for explaining the situation in which the light emitted from the light source reaches the observation object according to an example embodiment of the present disclosure.

FIG. 6B is a diagram illustrating the dark-field imaging method for explaining a situation in which light having passed through or reflected at the observation object reaches the image acquisition part according to an example embodiment of the present disclosure.

FIG. 7 is a diagram illustrating the bright-field imaging method for obtaining light scattered at the observation object and incident on an objective lens according to an example embodiment of the present disclosure.

### DETAILED DESCRIPTION

Example embodiments of the present disclosure will be described in detail with reference to the accompanying drawings for the clarification of the technical sprit of the present disclosure. Here, in the description of the present disclosure, when it is determined that a detailed description of a related known function or configuration may unnecessarily obscure the gist of the present disclosure, the detailed description thereof will be omitted. In the drawings, constituent elements that are substantially the same in configuration will be denoted by the same reference numeral and symbols as possible even if they are displayed on the other drawings. For the sake of convenience in description, both an apparatus and a method will be described if necessary. Operations described in the present disclosure may not be necessarily performed in a sequence described herein but may be performed in a parallel manner, a selective manner or an individual manner.

Terms used in example embodiments of the present disclosure are general terms that are currently widely used while their respective functions in the present disclosure are taken into consideration. However, the terms may be changed depending on the intention of one of ordinary skilled in the art, legal precedents, emergence of new technologies, and the like. Also, in particular cases, terms that are arbitrarily selected by the applicant of the present disclosure may be used, and in this case, the meanings of these terms may be described in detail in the corresponding disclosure. Accordingly, the terms used herein should be defined based on the meanings thereof and the content throughout the specification, instead of a simple name of the term.

In the present disclosure, expressions in the singular form should be understood to encompass expressions in the plural form unless the context clearly indicates otherwise. The term “comprises”, “includes”, “has” or the like are intended to include features, numeric characters, operations, acts, constituent elements, parts, or a combination thereof, and should be understood not to exclude one or more other features, numeric characters, operations, acts, constituent elements, parts, or a combination thereof, or additional features and the like. When a part “comprise or includes” a constituent element through the specification, this means that the part may further include other constituent elements, rather than excluding other constituent elements, unless other stated.

The expression such as “at least one” encompass the entire list of constituent elements and does not individually represent respective constituent elements in the list. For example, the expression “at least one of A, B, and C” may include the following meanings: “A alone”, “B alone”, “C alone”, “both A and B together”, “both A and C together”, “both Band C together”, or “all three of A, B, and C together”.

In addition, the terms such as “part,” “ - - - er, - - - or,” “module” and the like used herein may refer to a unit that performs at least one function or operation, which may be realized as hardware or software, or may be realized as a combination of hardware and software.

In the present disclosure, when one constituent element is referred to as being “connected” to another constituent element, the one constituent element may be “directly connected” to another constituent element, or may be “indirectly connected” or “electrically connected” to another constituent element by intervening yet another constituent element therebetween. When a part “comprise or includes” a constituent element through the specification, this means that the part may further include other constituent elements, rather than excluding other constituent elements, unless other stated.

The expression “configured (or set) to - - - ” described herein may be alternatively expressed to, for example, “suitable for - - - ,” “having the capacity to - - - ,” “designed to---,” “adapted to - - - ,” “made to - - - ,” “capable of - - - ,” or the like depending on situations. The expression “configured (or set) to - - - ” may not necessarily mean only “specifically designed to - - - ” in hardware. Alternatively, in some circumstances, the expression “system configured to - - - ” may mean that the system is “capable of - - - ” together with other apparatus(es) or constituent element(s). The phrase “processor configured (or set) to perform A, Band C” may mean, for example, a dedicated processor (for example, embedded process) configured to perform a respective operation, or a generic-purpose processor (for example, a central processing unit (CPU) or an application processor) capable of performing respective operations by executing one or more software programs stored in a memory.

The term “about” used in the present disclosure may refer to within 10% of a given value or range, specifically within 5%, more specifically within 1%.

As used herein, the term “specimen” is used interchangeably with a “sample” and may include all samples that are known in the related art as being observable by optical or light microscopes. For example, the “specimen” may include, but is not limited to, cells or tissues (such as animals, plants, fungus, protozoa, cells or tissues of bacteria, and the like: including all common or pathology cells/tissues), cell components (such as nuclei, cytoplasms, chloroplasts, mitochondrial, and the like), microbes (such as bacteria, protozoa, some avian, and fungus, and the like), organoids, and the like, but is not limited thereto.

The term “in-line illumination” used herein refers to an illumination method in which a light ray emitted from a light source passes through an objective lens, passes through an observation object and then passes through the objective lens again.

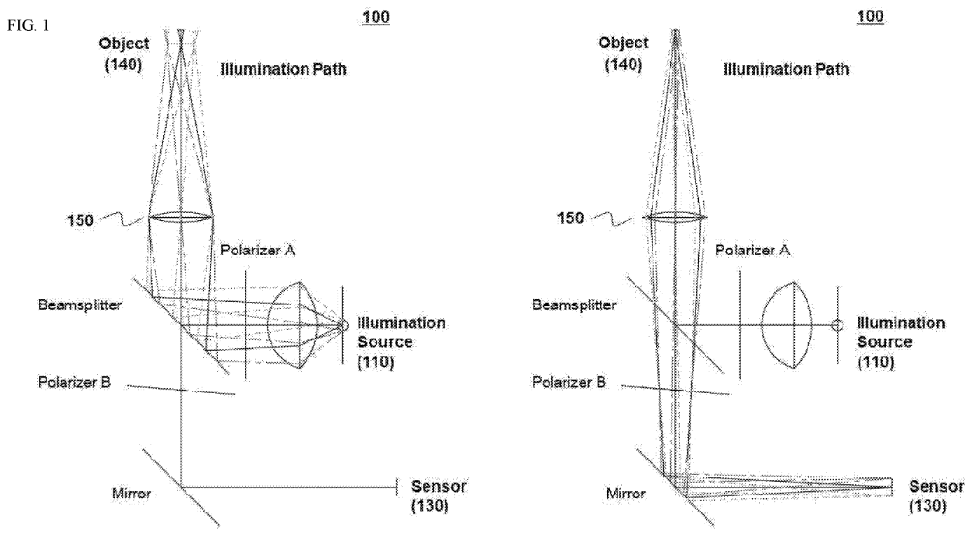

FIG. 1 is a diagram illustrating an observation apparatus using the in-line illumination method according to an example embodiment of the present disclosure.

Referring to FIG. 1, an observation apparatus 100 using the in-line illumination may include a light source 110, a light splitter 120 (for example, a beam splitter), an image sensor 130, an objective lens 150, a tube lens 160, a condenser lens, and the like. The observation apparatus 100 using the in-line illumination may include an optical apparatus implemented by combining illumination with an optical assembly using the light source 110 and the light splitter 120 and including the image sensor 130, the objective lens 150, the tube lens 160, and the like. In other words, the observation apparatus 100 using the in-line illumination may emit light necessary for imaging from an interior thereof without a separate external illumination. However, a method of using an external illumination may also be considered.

In an example embodiment, in a case in which the beam splitter arranged at a certain angle is used as the light splitter 120, a portion of the light emitted from the light source 110 may pass through the beam splitter, and the rest may be reflected at the beam splitter. For example, a 50:50 beam splitter may be arranged at an angle of 45 degrees. In this case, half of the light emitted from the light source 110 may transmit through the beam splitter, and the other half may be reflected at the beam splitter. However, this is merely an example. A transmission-reflection ratio of the light splitter 120 does not have to be 50:50, For example, the transmission-reflection ratio may appropriately be selected in a range of 0:100 to 100:0. Further, the arrangement angle of the light splitter 120 does not necessarily have to be 45 degrees, but may be set to an appropriate angle at which a portion of the light may be transmitted and the rest may be reflected.

In an example embodiment, in the observation apparatus 100 using the in-line illumination, the light splitter 120 may be positioned between the objective lens and the tube lens. Alternatively, the light splitter 120 may be positioned between the objective lens and the image sensor. This makes it possible to miniaturize the observation apparatus 100 using the in-line illumination as compared with other observation apparatuses using another illumination.

However, in spite of above-described advantages of the in-line illumination, the observation apparatus 100 using the in-line illumination may be difficult to use for observing microscopic objects such as cell units. This is because the light emitted from the light source 110 in the in-line illumination is too strong compared to light passing through a microscopic and transparent object such as a cell. Throughout this specification, the light having passed through the object may include light having reached the object, light having passed through the object, light scattered at the object, light reflected at the object, and the like.

That is, in observing a transparent object such as a cell, a shape of an observation object may be observed with light having passed through the observation object. Due to characteristics of the observation apparatus 100 using the in-line illumination in which the light splitter 120 is arranged in an imaging train path, the image sensor 130 receives not only the light having passed through the transparent microscopic observation object but also the strong light emitted from the light source 110 and passed through the light splitter 120. As a result, the image sensor 130 may not sufficiently sense the light passed through the transparent observation object.

Hereinafter, an observation apparatus 200, which is provided to solve the above-described matters, will be described.

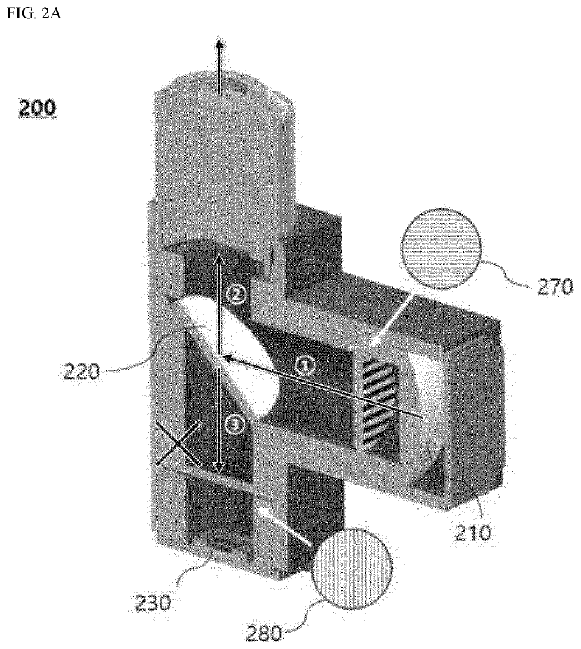

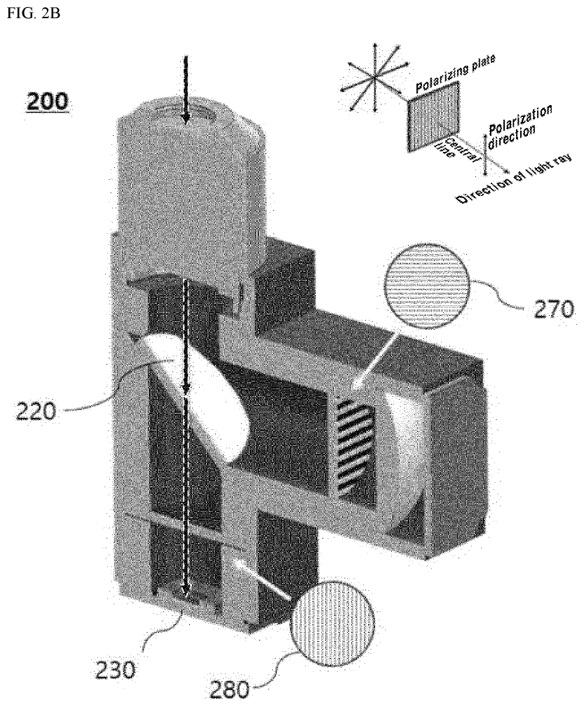

FIG. 2A is a diagram illustrating a situation in which the light emitted from the light source reaches the observation object according to an example embodiment of the present disclosure.

Referring to FIG. 2A, the observation apparatus 200 may include a light source 210, a light splitter 220, an image sensor 230, a first polarizer 270, a second polarizer 280, an objective lens, a tube lens, a condenser lens, and the like. However, all constituent elements illustrated in FIG. 2A are not essential constituent elements of the observation apparatus 200. The observation apparatus 200 may be implemented with more constituent elements than those illustrated in FIG. 2A. Alternatively, the observation apparatus 200 may be implemented with less constituent elements than those illustrated in FIG. 2A.

In an example embodiment, the observation apparatus 200 according to an example embodiment of the present disclosure may use the in-line illumination method. The light splitter 220 may be positioned between the objective lens and the tube lens. Alternatively, the light splitter 220 may be positioned between the objective lens and the image sensor 230. Further, the condenser lens may be positioned between the light source 210 and the first polarizer 270. Further, the tube lens may be positioned between the second polarizer 280 and the image sensor 230.

In an example embodiment, the observation apparatus 200 may observe an “observation target” or “observation object” as defined herein and may include a microscope, a live cell imaging device, and the like, but is not limited thereto. In another example embodiment, the observation apparatus 200 may be used to inspect parts or components used in the field of industrial applications other than bio-applications, such as a semiconductor or a display equipment and related industries, in addition to the “observation object” as defined herein.

In an example embodiment, the light source 210 may emit light. As illustrated in FIG. 2A, the light source 210 may be positioned inside or outside the observation apparatus 200. In an example embodiment, in the case in which the light source 210 is positioned outside the observation apparatus 200, the observation apparatus 200 and the light source 210 may be positioned on the same plane with reference to the observation object. For example, in a case in which the observation apparatus 200 is positioned below the observation object, the light source 210 may also be positioned below the observation object.

Throughout this specification, the “observation target” or the “observation object,” which is a target to be observed by the observation apparatus, may be the term “specimen” or “sample” defined herein, for example, cells, tissues, microorganisms, microparticles, blood plasmas, or the like. Here, examples of the microparticle may include red blood cells, platelets, white blood cells, circulating tumor cells, stem cells, effect-stored erythrocytes, T-cells derived from autologous T-cell expansion, organic microparticles, inorganic microparticles, organometallic microparticles, metallic microparticles, aerosol particles, bacteria, yeast, fungi, algae, viruses, microinvertebrates or their eggs, pollen, cell or tissue fragments, cluster of cells, cell debris (for example, cell debris associated with DNA or RNA purification), bioreactor-produced cells or granules, proteins, protein aggregates, prions, vesicles, liposomes, precipitates (for example, precipitates from blood or blood fractions, industrial process precipitates, wastewater precipitates, or the like), granules or cells derived from fermented foods (for example, granules or cells derived from fermented beverages), macromolecules, macromolecular aggregates, DNA, cell organs, spores, bubbles, droplets, and exosomes, and the like.

In the present disclosure, the terms “observation target” and “observation object” are used interchangeably with each other and are concepts included in an “object”, which is sometimes simply referred to as an “object.” That is, the object refers to the “observation target” or the “observation object” defined herein. However, it should be noted that, according to the context, the object may refer to an object at which light is reflected, transmitted and scattered, for example, a vessel, a lid of the vessel, dust, or the like.

In an example embodiment, the light emitted from the light source 210 may be polarized by the first polarizer 270 that polarizes light in a first direction. The first polarizer 270 may include a polarizing plate that polarizes the light emitted from the light source 210 in the first direction, a polarizing filter, an analyzer, and the like. For example, the light emitted from the light source 210 may include light that oscillates in all directions. When such light reaches the first polarizer 270, only the light that oscillates in the first direction passes through the first polarizer 270, and the remaining light is entirely blocked. Thus, the light having passed through the first polarizer 270 may include only the light that oscillates in the first direction.

In an example embodiment, the light (light \textcircled{1} in FIG. 2A) having passed through the first polarizer 270 may be separated or divided into a first reflected light (light \textcircled{2} in FIG. 2A) and a first transmitted light (light \textcircled{3} in FIG. 2A) by the light splitter 220. In this case, the first reflected light (light \textcircled{2} in FIG. 2A) and the first transmitted light (light \textcircled{3} in FIG. 2A) are ones divided from the light (light \textcircled{1} in FIG. 2A) having passed through the first polarizer 270. These lights may have the same magnitudes in period, frequency and wavelength as those of the light (light \textcircled{1} in FIG. 2A) having passed through the first polarizer 270.

In an example embodiment, the first transmitted light (light \textcircled{3} in FIG. 2A) may travel toward the image sensor 230. However, the first transmitted light (light \textcircled{3} in FIG. 2A) may also include light that should not be incident on the image sensor 230 from the viewpoint of clearly observing the observation object. Thus, the second polarizer 280 may be arranged in a path along which the first transmitted light (light \textcircled{3} in FIG. 2A) having passed through the light splitter 220 travels toward the image sensor 230. Therefore, the second polarizer 280 may block the first transmitted light (light \textcircled{3} of FIG. 2A) from being detected by the image sensor 230. To this end, the second polarizer 280 may include a polarizing plate that polarizes light in the second direction, a polarizing filter, an analyzer, and the like in order to block the first transmitted light (light \textcircled{3} in FIG. 2A). However, this configuration is merely an example. The second polarizer 280 may be replaced with another device for blocking the first transmitted light in addition to the device for performing polarization.

For example, in a case in which the first polarizer 270 is a lateral polarizing plate, when the light emitted from the light source 210 passes through the first polarizer 270, only light (light \textcircled{1} in FIG. 2A) that oscillates in a lateral direction passes through the first polarizer 270. This light may be the first transmitted light (light \textcircled{3} in FIG. 2A) that oscillates in the lateral direction while passing through the light splitter 220. A longitudinal polarizing plate may be used in the second polarizer 280 to block the first transmitted light (light \textcircled{3} in FIG. 2A). As another example, in the case in which the longitudinal polarizing plate is used in the first polarizer 270, a lateral polarizing plate may be used in the second polarizer 280. However, this configuration is merely one example. The second polarizer 280 may be provided with various devices for blocking the first transmitted light (light \textcircled{3} in FIG. 2A).

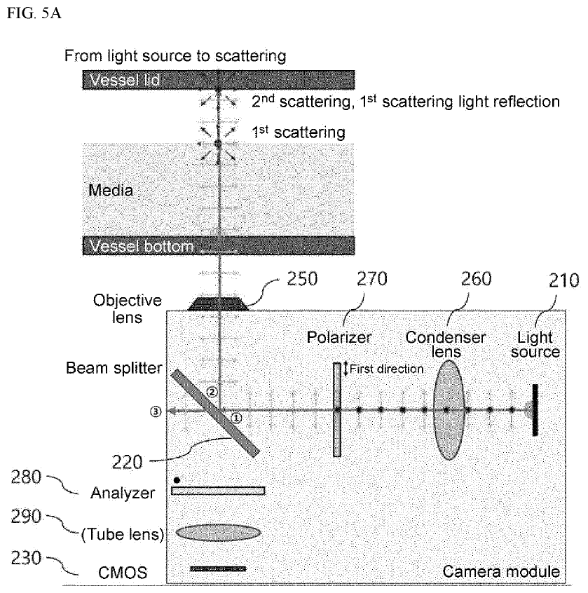

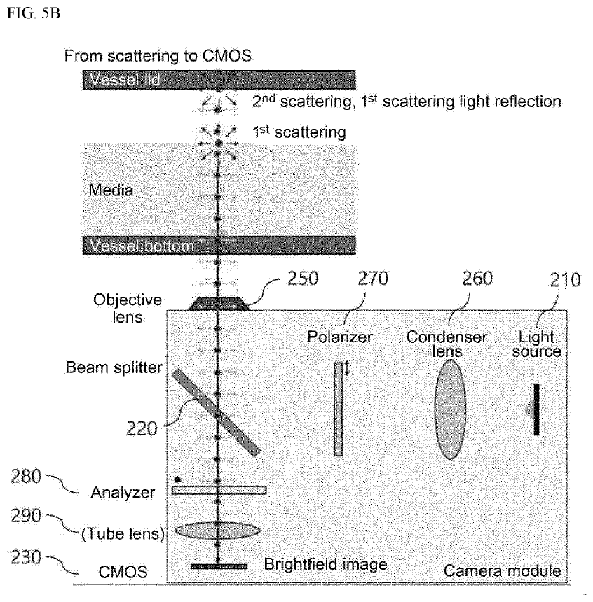

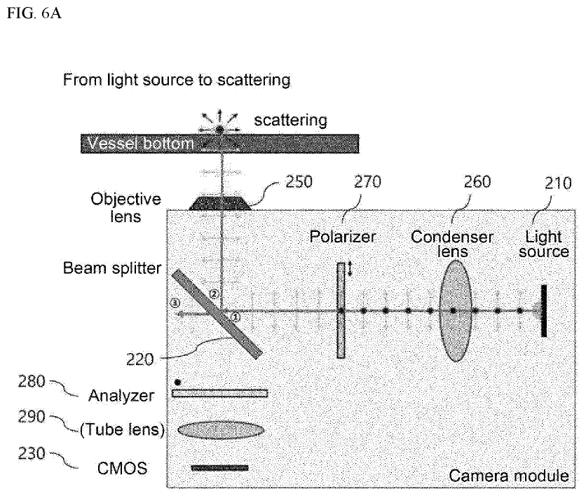

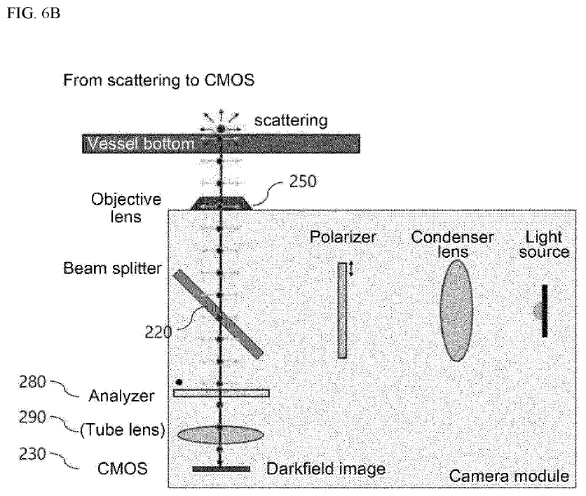

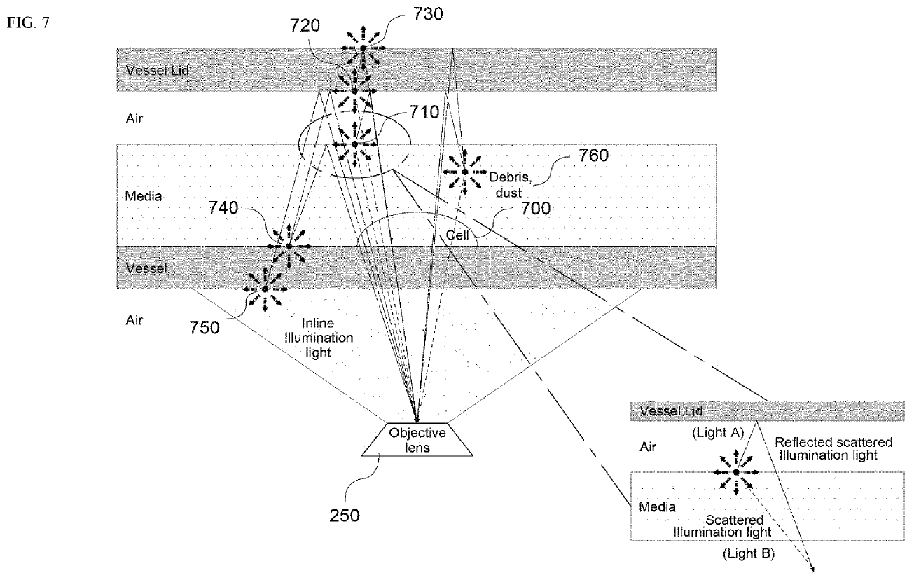

In an example embodiment, the first reflected light (light \textcircled{2} in FIG. 2A) may pass through the objective lens and reach the observation object. The first reflected light (light \textcircled{2} in FIG. 2A) may function as an illumination necessary for the observation of the observation object. For example, the first reflected light having passed through the objective lens may be scattered above the observation object. Among the light scattered above the observation object, the light having passed through the observation object may be collected by the objective lens again as light including information about the observation object. In this case, the light scattered above the observation object may include light scattered directly above the observation object (for example, a surface of media), light that is reflected at a position (for example, an upper plate of the vessel) higher than the above of the observation object (for example, the surface of the media) and returns again, or the like. This will be described in more detail below with reference to FIGS. 5A, 5B and 7. As another example, the first reflected light having passed through the objective lens may be scattered at the observation object, and at least a portion of the scattered light may be collected by the objective lens again. This will be described in more detail below with reference to FIGS. 6A and 6B.

In this case, the first reflected light (light \textcircled{2} in FIG. 2A) may include only the light polarized in the first direction by the first polarizer 270 because it passes through the first polarizer 270. The first reflected light having a directionality only in the first direction may be reflected or scattered at a certain object when reaching the certain object. Such reflected light still has a directionality in the first direction, while the scattered light may lose such directionality and have random directionality. Unlike the related art in which scattering of light is regarded as a loss of light, an example embodiment of the present disclosure provides an observation method of using the scattered light as the illumination. Hereinafter, a situation in which the light having the random directionality returns to the objective lens will be described below with reference to FIG. 2B.

FIG. 2B is a diagram illustrating a situation in which the light having passed through the observation object reaches the image acquisition part according to an example embodiment of the present disclosure.

Referring to FIG. 2B, light available when the first reflected light is scattered above the observation object or in the observation object may pass through the objective lens again and may pass through the light splitter 220.

In an example embodiment, at least a portion of the light scattered above the observation object may pass through or be reflected at the observation object, so that the at least a portion of the light may include information about the observation object.

Throughout this specification, “above the observation object” refers to an upper side of the observation object, that is, an opposite direction of the observation apparatus with reference to the observation object. For example, when the observation apparatus observes the observation object contained in media (or culture medium) from below, “above the observation object” may include the surface of the media (or culture medium), the lid of the vessel, and other objects existing above the observation object, such as dust, air, or the like.

Throughout this specification, the expression “light including information about the object” refers to light including information such as a shape, position, structure, component, concentration, or time-dependent change of the observation object while performing interaction (for example, absorption, reflection, refraction, scattering, fluorescence expression, or the like) with the observation object (for example, cells, tissues, or other biological specimens, or the like). This light may be light generated or modified by interacting with the observation object in a physical, chemical, or biological manner. Thus, the light may include information for estimating or determining a physical property or biological state of the observation object.

In another example embodiment, the light scattered at the observation object may also include information about the observation object.

The light including the information about the observation object as described above may travel toward-the second polarizer 280 which polarizes light in the second direction. In this case, among the light including the information about the observation object, only the light oscillating in the second direction passes through the second polarizer 280, and the rest is blocked by the second polarizer 280. Thus, the light having passed through the second polarizer 280 may include only the light that oscillates in the second direction. For example, the second polarizer 280 may polarize, in the second direction, the first transmitted light as well as light available when the first reflected light is reflected or scattered at the observation object, the vessel, the surface of the media, or the like and returns the objective lens. Since the reflected light has the directionality polarized by the first polarizer 270 as it is, the reflected light cannot pass through the second polarizer 280, and only the light that has lost the directionality due to scattering may pass through the second polarizer 280. Thus, the image sensor 230 may obtain the scattered light polarized by the second polarizer 280. In an example embodiment, the light detected by the image sensor 230 may include a transmitted light available when the first reflected light (light \textcircled{2} in FIG. 2A) is scattered above the observation object and the scattered light passes through the object, a scattered light available when the first reflected light (light \textcircled{2} in FIG. 2A) is scattered at the observation object, or the like.

Accordingly, the image sensor 230 may sense only the scattered light at least once. Therefore, the image sensor 230 may image only a small amount of light including the information about the observation object while being hardly influenced by the light source 210, which images a small level of weak light.

In an example embodiment, a path along which the light detected by the image sensor 230 travels from the light splitter to the second polarizer may coincide with a path along which the first transmitted light travels from the light splitter to the second polarizer.

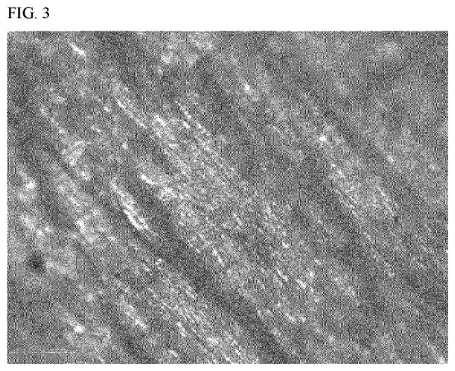

FIG. 3 is a diagram illustrating an image obtained by observing a macroscopic object using the observation apparatus according to an example embodiment of the present disclosure.

Referring to FIG. 3, a result obtained by observing the macroscopic object using the observation apparatus 200 is illustrated. In an example embodiment, when the first reflected light reaches the macroscopic object, is reflected or scattered at the macroscopic object and returns the objective lens, the image sensor senses light having passed through the light splitter 220 and the second polarizer 280 among the light reflected or scattered at the macroscopic object. In this case, the background may be imaged darkly and the macroscopic object may be imaged lightly. Thus, when observing the macroscopic object, as illustrated in FIG. 3, an image may be obtained on a principle similar to that of a dark-field microscope.

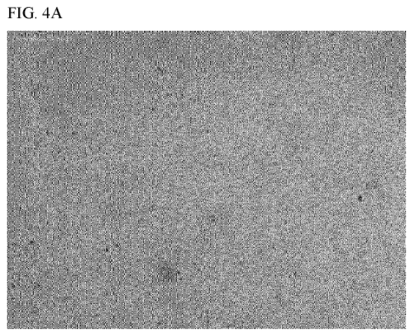

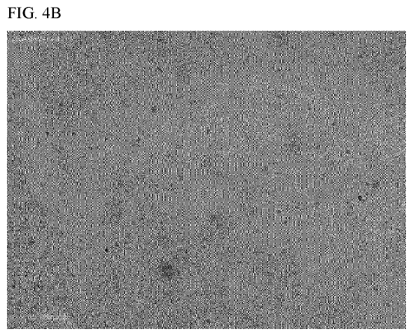

FIGS. 4A and 4B are diagrams illustrating images obtained by observing the microscopic object using the observation apparatus according to an example embodiment of the present disclosure.

FIGS. 4A and 4B illustrate observation results obtained by observing a flat portion, such as a central portion of a vessel when observing media including a microscopic object such as cells, according to an example embodiment of the present disclosure. In this case, reflection or scattering of light may occur at a boundary surface of the media. Thus, the boundary surface of the media functions like a mirror to perform the role of the illumination. Thus, as illustrated in FIGS. 4A and 4B, the background may be imaged brightly and the microscopic object such as cells may be imaged darkly.

FIG. 5A is a diagram illustrating a bright-field imaging method for explaining the situation in which the light emitted from the light source reaches the observation object according to an example embodiment of the present disclosure.

In FIG. 5A, an observation method in the bright-field imaging according to an example embodiment is illustrated in, for example, a case in which the observation object is accommodated in a vessel or is immersed in media. The light emitted from the light source 210 may pass through the condenser lens 260. The condenser lens 260 may perform a role of collecting and irradiating the light emitted from the light source 210. The light having passed through the condenser lens 260 may be polarized by the first polarizer 270. For example, the first polarizer 270 may pass only light that oscillates in the first direction among the light having passed through the condenser lens 260, and block other light. Therefore, as illustrated in FIG. 5A, only the light (light \textcircled{1} in FIG. 5A) that oscillates in the first direction among the light that has oscillated in all directions before passing through the first polarizer 270 may reach the light splitter 220.

In an example embodiment, the light (light \textcircled{1} in FIG. 5A) having reached the light splitter 220 may be divided into a first reflected light (light \textcircled{2} in FIG. 5A) and a second transmitted light (light \textcircled{3} in FIG. 5A). Both the first reflected light (light \textcircled{2} in FIG. 5A) and the second transmitted light (light \textcircled{3} in FIG. 5A) may oscillate in the first direction as the light having passed through the first polarizer 270.

In an example embodiment, the second polarizer 280 may block the second transmitted light (light \textcircled{3} in FIG. 5A) that oscillates in the first direction. In this case, the second transmitted light may pass through the first polarizer and pass in the same direction as the direction \textcircled{1} of FIG. 5A, and may travel toward the second polarizer by being reflected at a structure wall or the like. To this end, the second polarizer 280 may be a device for polarizing light in the second direction rather than the first direction. For example, the second direction may be set by an angle of 90 degrees with respect to the first direction. However, this configuration is merely an example, and the second direction may not be set by the angle of 90 degrees with respect to the first direction as long as they are different from each other.

In an example embodiment, the first reflected light (light \textcircled{2} in FIG. 5A) may pass through the objective lens 250 to reach the observation object. Here, the observation object may be a concept that encompassing a vessel, a lid of the vessel, dust, or the like, in addition to an observation object such as cells, samples, or the like. In an example embodiment, the first reflected light (light \textcircled{2} in FIG. SA) may be reflected or scattered above the observation object and travel toward the objective lens again. For example, as illustrated in FIG. SA, the light traveling toward the objective lens may include (a) light available when the first reflected light (light \textcircled{2} in FIG. SA) is reflected above the media and is primarily scattered, (b) light available when the first reflected light reaches the upper plate of the vessel (for example, the lid of the vessel) and is secondary scattered while being reflected at the upper plate, (c) light available when a portion of the light primarily scattered above the media (for example, the surface of the media) reaches the upper plate of the vessel (for example, the lid of the vessel) and is reflected or scattered at the upper plate, (d) light available when the first reflected light is scattered as coming into contact with dust, or the like. Such light (a) to (d) may pass through the observation object when traveling toward the objective lens again so that they include the information about the observation object.

In an example embodiment, the vessel may include a lower plate and the upper plate or may include the lower plate alone.

According to an example embodiment of the present disclosure, when the vessel includes the upper plate (for example, the lid of the vessel), the objective lens may further collect light reflected or scattered at the upper plate of the vessel, and may obtain a relatively bright image. Such light, which includes the light including the information about the observation object, may be collected by the objective lens 250 again. This will be described later with reference to FIG. 5B.

FIG. 5B is a diagram illustrating the bright-field imaging method for explaining a situation in which the light scattered or reflected at the observation object reaches the image acquisition part according to an example embodiment of the present disclosure.

Referring to FIG. 5B, the objective lens 250 may collect a portion of the light scattered above the observation object, for example, on the lid of the vessel, the surface of the media, or the like. Such light may include information about the observation object by passing through the observation object before or after being scattered. The light collected by the objective lens 250 may also travel toward the image sensor 230. That is, the image sensor 230 may sense the light input thereto based on the light collected by the objective lens 250.

Further, since the second polarizer 280 is present in front of the image sensor 230, the image sensor 230 may sense only light that has lost directionality due to scattering. For example, the image sensor 230 may sense a transmitted light available when the first reflected light is scattered above the object and the scattered light passes through the observation object. Meanwhile, the objective lens 250 may also collect light reflected at the observation object, the vessel, the surface of the media, or the like. However, such reflected light does not change in polarization property when not being scattered. Thus, the reflected light is blocked by the second polarizer 280 and the image sensor 230 does not sense such non-scattered light.

In an example embodiment, the image sensor is a sensor that converts light passing through the tube lens 290 into an electrical digital signal, and may include a complementary metal oxide semiconductor (CMOS), and the like. For example, the light having passed through the objective lens 250 may pass through the light splitter 220, the second polarizer 280, and the tube lens 290 in the named order and then reach the image sensor 230. That is, the light splitter 220 may be positioned between the objective lens 250 and the tube lens 290. Accordingly, the image sensor 230 may obtain a bright-field image in which the information about the observation object is displayed darkly in a bright background.

FIG. 6A is a diagram illustrating a dark-field imaging method for explaining a situation in which the light emitted from the light source reaches the observation object according to an example embodiment of the present disclosure.

Referring to FIG. 6A, unlike FIG. 5A, there is illustrated an observation method in a dark-field imaging according to an example embodiment in a case in which the observation object does not exist in the media and exists above the vessel without the media.

In an example embodiment, the light emitted from the light source 210 passes through the condenser lens 260, and the light having passed through the condenser lens 260 may be polarized by the first polarizer 270. For example, the first polarizer 270 may pass only light that oscillates in the first direction among the light having passed through the condenser lens 260 and oscillating in all directions, and block other light. Therefore, as illustrated in FIG. 6A, only the light (light \textcircled{1} in FIG. 6A) that oscillates in the first direction among the light that oscillates in all directions before passing through the first polarizer 270 may reach the light splitter 220.

In an example embodiment, the light (light \textcircled{1} in FIG. 6A) having reached the light splitter 220 may be divided into a first reflected light (light \textcircled{2} in FIG. 6A) and a second transmitted light (light \textcircled{3} in FIG. 6A). Both the first reflected light (light \textcircled{2} in FIG. 6A) and the second transmitted light (light \textcircled{3} in FIG. 6A) may be lights which have passed through the first polarizer 270 and oscillate in the first direction.

In an example embodiment, the second polarizer 280 may block the second transmitted light (light \textcircled{3} in FIG. 6A) that oscillates in the first direction. In this case, the second transmitted light may pass through the first polarizer, travel in the same direction as the direction indicated in FIG. 5A, is reflected at a structure wall or the like, and travel toward the second polarizer. To this end, the second polarizer 280 may be a device that polarizes light in the second direction rather than the first direction.

In an example embodiment, the first reflected light (light \textcircled{2} in FIG. 6A) may pass through the objective lens 250 and reach the observation object. Here, the observation object may refer to an observation target placed on a vessel, or an observation target (not illustrated) placed directly on an objective table without the vessel. In an example embodiment, the first reflected light (light \textcircled{2} in FIG. 6A) may reach and pass through the observation object, or may be reflected or scattered at the observation object. A portion of the scattered light may travel toward the objective lens again. Thus, as in the example of FIG. 6A, the light traveling toward the objective lens may be light scattered by the observation object, and may include information about the observation object. Thus, unlike FIG. 5A, in FIG. 6A, the dark-field imaging may be performed. A situation after the light scattered at the observation object travels toward the objective lens will be described later with reference to FIG. 6B.

FIG. 6B is a diagram for explaining a dark-field imaging method for explaining a situation in which the light having passed through or reflected at the observation object reaches the image acquisition part according to an example embodiment of the present disclosure.

Referring to FIG. 6B, the objective lens 250 may collect a portion of light scattered when passing through the observation object or being reflected at the observation object. Such scattered light may include the information about the observation object as described with reference to FIG. 6A. Further, the light collected by the objective lens 250 may travel toward the image sensor 230. That is, the image sensor 230 may sense light input thereto based on the light collected by the objective lens 250.

Meanwhile, since the second polarizer 280 is provided in front of the image sensor 230, the image sensor 230 may sense only light that has lost directionality due to scattering. For example, the image sensor 230 may sense scattered light available when the first reflected light is scattered at the observation object.

In an example embodiment, the light having passed through the objective lens 250 may pass through the light splitter 220, the second polarizer 280, and the tube lens 290 in the named order and reach the image sensor 230. Accordingly, the image sensor 230 may obtain a dark-field image in which the information about the observation object is displayed brightly.

FIG. 7 is a diagram illustrating a bright-field imaging method for obtaining light scattered at the observation object and incident on the objective lens according to an example embodiment of the present disclosure.

In FIG. 7, in the bright-field imaging method according to an example embodiment described with reference to FIGS. 5A and 5B, the light scattered at the observation object and incident on the objective lens is more specifically displayed.

In an example embodiment, the light polarized in the first direction is reflected by the light splitter, and the light reflected by the light splitter may pass through the objective lens 250 to entirely reach a field of view (opening) of the observation apparatus 200. In this case, the field of view (opening) may refer to a region where the observation object 700 can be observed.

In an example embodiment, the light having passed through the objective lens 250 may be scattered at a surface 710 of the media. A portion (hereinafter, referred to as “light A”) of the light scattered at the surface 710 of the media in this way travels upward, that is, toward a lower surface of the lid of the vessel. The light A may be reflected at the lid of the vessel and travel toward the objective lens 250 again. The objective lens 250 may also collect Light A which is reflected at the lid of the vessel and reaches the objective lens 250. In addition, another portion (hereinafter, referred to as “light B”) of the light scattered at the surface 710 of the media may travel downward, that is, toward the objective lens 250 again. The objective lens 250 may collect the light B which is reflected or scattered at the surface 710 of the media and reaches the objective lens 250.

In an example embodiment, the light having passed through the objective lens 250 may be reflected and scattered at a lower surface 720 of the lid of the vessel. A portion (hereinafter, referred to as “light C”) of the light, which is reflected and scattered at the lower surface 720 of the lid of the vessel, travels toward the objective lens 250 again. The objective lens 250 may collect light C.

In an example embodiment, the light having passed through the objective lens 250 may be reflected and scattered at an upper surface 730 of the lid of the vessel. A portion (hereinafter, referred to as “light D”) of the light, which is reflected and scattered at the upper surface 730 of the lid of the vessel, travels toward the objective lens 250 again. The objective lens 250 may collect light D.

In an example embodiment, the light having passed through the objective lens 250 may be reflected or scattered at the surface of the media, the lower surface of the lid of the vessel, the upper surface of the lid of the vessel, or the like to reach an upper surface 740 of the vessel. Such light may be reflected and scattered at the upper surface 740 of the vessel. A portion (hereinafter, referred to as “light E”) of the light, which is reflected or scattered at the upper surface 740 of the vessel, travels toward the objective lens 250 again. The objective lens 250 may collect light E.

In an example embodiment, the light having passed through the objective lens 250 may be reflected at the surface of the media, the lower surface of the lid of the vessel, the upper surface of the lid of the vessel, or the like to reach the lower surface 750 of the vessel. Such light may be reflected or scattered at the lower surface 750 of the vessel. A portion (hereinafter, referred to as “light F”) of the light, which is reflected or scattered at the lower surface 750 of the vessel after having passed through the observation object 700, travels toward the objective lens 250 again. The objective lens 250 may collect light F.

In an example embodiment, the light having passed through the objective lens 250 may be scattered by foreign matters 760, such as dust. A portion (hereinafter, referred to as “light G”) of the light, which is scattered by the foreign matters 760, may travel toward the objective lens 250 again.

In an example embodiment, the objective lens 250 may collect light A to light G, including the information about the observation object 700 by passing through the observation object 700. However, this configuration is merely an example. The objective lens 250 may collect additional light other than light A to light G, or may collect only some of light A to light G. The light collected by the objective lens, such as light A to light G, may include the information about the observation object 700 by passing through the observation object 700. By the light generated by passing through the observation object, the bright-field imaging of darkly displaying the observation object when the light passes the observation object may be implemented.

The observation method according to an example embodiment of the present disclosure may include: scattering at least a portion of light emitted from a light source at an observation object or above the observation object; and sensing at least one of a scattered light scattered at the observation object or a transmitted light having passed through the observation object after being scattered above the observation object.

According to an example embodiment of the present disclosure, since the scattered light is collected, it is possible to obtain a clear observation image even if the lower surface or the like of the vessel in which the observation object is accommodated is opaque or uneven.

According to an example embodiment of the present disclosure, the vessel in which the observation object is accommodated may be made of an optically transparent material. Examples of the vessel may include all types of vessels which are capable of accommodating an object to be observed, and a structure or shape of the vessel is not particularly limited.

According to an example embodiment, the vessel may provide a surface for culturing, growing and functioning adherent cells, suspension cells, stem cells, tumor cells, immune cells, neuronal cells, or other mammalian-derived cells. The vessel may be used without any limitation as long as it can cultivate, grow, and function objects included in the “observation object” defined herein in addition to these cells.

In an example embodiment, the vessel (container) may include various forms of culture vessels. The vessels may be classified into a monolayer vessel, a multi-layer vessel, a three-dimensional (3D) culture vessel, and a bioreactor-based vessel according to a structure and culture scheme. Examples of the vessel may be as follows but are not limited thereto.
(1) The monolayer vessel has a structure in which cells are cultivated in one plane, and may include a T-flask, a Petri dish, a slide glass, a multi-well plate, a chamber slide, a microfluidic chip, a cover glass, and the like, but is not limited thereto.
(2) The multi-layer vessel has a structure in which a plurality of cell culture surfaces in a vertical or oblique direction are provided, individual layers function as separate culture spaces, and an optical external access is limited. Unlike an optical system in the related art in which a cell in a specific layer is less likely to be observed, the optical system of the present disclosure has been designed to solve such matters using the above-described structure.

Examples of the multi-layer vessel may include CellSTACK™, HYPERStack™, HYPERFlask®, TripleFlask™, Falcon Cell Culture Multi-Layer Flask, Cell Factory™ produced by Thermo Fisher Scientific Company, Nunc™ EasyFill™, STACKMAX™ produced by Sartorius Company, iCELLis™ Nano and iCELLis™ 500+produced by Cytiva Company, and the like, but is not limited thereto.
(3) The 3D culture vessel has a structure that provides an environment in which cells may grow sterically. Examples of the 3D culture vessel may include a spheroid, an organoid, a hydrogel-based culture system, a structure using a scaffold, and a suspension culture. In these examples, since cells are distributed at various depths, they may be less likely to optically observed.
(4) The bioreactor-based vessel is a device for continuous culture environment control and mass culture. Examples of the bioreactor-based vessel may include a spinner flask, a wave-type bioreactor, a small-scale bioreactor chamber, and the like.

The optical system according to an example embodiment of the present disclosure may overcome structural and optical limitations that occur in the multi-layer vessel and the 3D cell culture system, and effectively observe cells presenting in individual layers or individual depths, which makes it possible to improve the accuracy and reproducibility of cell culture and analysis.

The vessel according to an example embodiment of the present disclosure may have a structure in which a ceiling plate or a lid is provided, or a structure in which the ceiling plate or the lid is not provided. For example, the structure without the ceiling plate may include a vessel having an open-top structure, such as a general Petri dish, slide glass, and multi-well plate. With a structure, even in an environment in which an upper portion of the vessel is open so that an additional reflective member is difficult to be provided, no reflective member is required above the vessel or above the sample.

The observation apparatus according to an example embodiment of the present disclosure may be an apparatus for imaging an observation object in real time or at a period of time to visually observe the observation object, or analyze image data. The observation apparatus may be configured to be capable of monitoring, with time, a morphological change, movement, differentiation, functional response, or the like of an observation object, such as cells, tissues, or biological samples.

According to an example embodiment, the observation apparatus may be an apparatus for a live cell imaging system, which may be a system designed to observe a state of cells for a long period of time while maintaining a living environment of a live cell.

In an example embodiment, the case in which the observation apparatus according to an example embodiment of the present disclosure is the live cell imaging system, the observation apparatus generally operates in an environment where CO₂, temperature, humidity are controlled. In typical, the observation apparatus may be installed and driven inside a commercially available incubator. In another example embodiment, the observation apparatus may include a separately mountable incubator module to perform an imaging while providing an independent culture environment for live cells.

Further, the observation apparatus may include an optical system such as an optical microscope, a fluorescence microscope, a phase difference or confocal microscope, or the like, and may be implemented with various constituent elements such as an image sensor (CMOS, CCD, or the like), an illumination unit, a lens system, a focusing device, an image processing software, and the like.

The system may support a variety of observation modes, such as a time-lapse imaging, a Z-stack imaging, a high-speed imaging in addition to a static imaging.

An example embodiment of the present disclosure may be implemented in the form of a recording medium recording computer-executable instructions such as computer-executable program modules. A computer-readable medium may be any available medium to which the computer may access, and may include both a volatile and nonvolatile medium, a removable and a non-removable medium. Further, the computer-readable medium may include both a computer storage medium and a communication medium. The computer storage medium includes both a volatile and nonvolatile medium, and a removable and nonremovable medium, which are implemented by any method or technology for storing information, such as computer-readable instructions, data structures, a program modules or other data. In typical, the communication medium may include computer-readable instructions, data structures, or program modules, and may include any information delivery medium.

The above descriptions of the present disclosure are merely examples and the present disclosure may be changed in other specific forms by those skilled in the art without altering the technical ideas or essential features of the present disclosure. Therefore, the example embodiments described above should be understood to be illustrative in all respects and not restrictive. For example, individual constituent elements described in a singular form may be implemented in a distributed fashion. Similarly, the constituent elements described to be distributed may be implemented in a combined form.

Therefore, the spirit of the present disclosure need not to be limited to the above-described example embodiments, and in addition to the appended claims to be described below, and all ranges equivalent to or changed from these claims need to be said to belong to the scope and spirit of the present disclosure.

What is claimed is:

1. An observation apparatus comprising:
a first polarizer configured to polarize light emitted from a light source;
a light splitter configured to split the light having passed through the first polarizer into a first reflected light and a first transmitted light;
an objective lens configured to collect light including information about an object based on the first reflected light;
an image sensor configured to detect input light based on the light collected by the objective lens; and
a second polarizer configured to block the first transmitted light so that the first transmitted light is not detected by the image sensor.

2. The observation apparatus of claim 1, wherein the light detected by the image sensor includes:
a transmitted light available when the first reflected light is scattered above the object and the scattered light passes through the object; or
a scattered light available when the first reflected light is scattered at the object.

3. The observation apparatus of claim 2, wherein the light available when the first reflected light is scattered above the object includes light scattered by at least one of an upper plate of a vessel or a surface of media.

4. The observation apparatus of claim 3, wherein the light collected by the objective lens includes a reflected light reflected by at least one of the object, the vessel, or the surface of the media, and
wherein the reflected light, which has not been scattered, is blocked by the second polarizer.

5. The observation apparatus of claim 1, further comprising: the light source provided inside the observation apparatus.

6. The observation apparatus of claim 1, wherein a polarization angle of the first polarizer is set by 90 degrees with respect to a polarization angle of the second polarizer.

7. The observation apparatus of claim 1, wherein the second polarizer is configured to polarize the light collected by the objective lens, and
wherein the image sensor is configured to obtain the light polarized by the second polarizer.

8. The observation apparatus of claim 1, wherein the object is accommodated in a single-layer vessel or a multi-layer vessel.

9. The observation apparatus of claim 8, wherein the multi-layer vessel is a CelISTACK™, HYPERStack™, Cell Factory™, Nune™ EasyFill™ cell Factory, Falcon® Cell Culture Multi-Layer Flask, STACKMAX™, iCELLis™ Nano and iCELLis™ 500+, TripleFlask™ system, or HYPERFlask®.

10. The observation apparatus of claim 1, wherein the object is accommodated in a vessel, and
wherein the vessel includes a lower plate and an upper plate, or includes the lower plate alone.

11. The observation apparatus of claim 1, wherein the object is accommodated in a vessel made of an optically transparent material.

12. The observation apparatus of claim 1, wherein the observation apparatus is a live cell imaging system.

13. An observation method, comprising:
emitting, by a light source, light;
polarizing, by a first polarizer, the light emitted from the light source;
splitting, by a light splitter, the light having passed through the first polarizer into a first reflected light and a first transmitted light;
blocking, by a second polarizer, the first transmitted light so that the first transmitted light is not detected by an image sensor;
collecting, by an objective lens, light including information about an object based on the first reflected light; and
sensing, by the image sensor, light input to the image sensor based on the light collected by the objective lens.

14. The observation method of claim 13, wherein the light detected by the image sensor includes:
a transmitted light available when the first reflected light is scattered above the object and the scattered light passes through the object; or
a scattered light available when the first reflected light is scattered at the object.

15. An observation method, comprising:
scattering at least a portion of light emitted from a light source at an object or above the object; and
sensing the light scattered at the object or a transmitted light available when the light is scattered above the object and subsequently passes through the object.
